(19) United States
(12) Patent Application Publication
(10) Pub. No.: US 2026/0210816 A1
(43) Pub. Date: Jul. 23, 2026

(54) TISSUE SAMPLE PREPARATION

(71) Applicants: Tispa Medical B.V., Weesp (NL); Stichting ISALA Klinieken, Zwolle (NL)

(72) Inventors: Geert Feye WOERLEE, WEESP (NL); Ian Ranald SPOELSTRA, Weesp (NL); Marco Gerardus Cornelis VAN DE GRIFT, Zwolle (NL); Agnes Marije HOOGLAND, Zwolle (NL)

(73) Assignees: Tispa Medical B.V., Weesp (NL); STICHTING ISALA KLINIEKEN, Zwolle (NL)

(21) Appl. No.: 19/133,554

(22) PCT Filed: Nov. 28, 2023
(86) PCT No.: PCT/NL2023/050621

§ 371 Date: May 28, 2025

(30) Foreign Application Priority Data
Nov. 28, 2022 (NL) 2033625
Apr. 17, 2023 (NL) 2034598

(51) Int. Cl. G01N 1/30

(52) U.S. Cl. CPC G01N 1/30

(57) ABSTRACT

The present invention is in the field of a method for tissue sample preparation, in particular for further investigation of the tissue sample, such as for chemical, physical, or biological investigation thereof. The prepared tissue sample may be used for histological analysis. The tissue sample is typically a biological sample.

### FIELD OF THE INVENTION

The present invention is in the field of a method for tissue sample preparation, in particular for further investigation of the tissue sample, such as for chemical, physical, or biological investigation thereof. The prepared tissue sample may be used for histological analysis. The tissue sample is typically a biological sample.

### BACKGROUND OF THE INVENTION

Histology relates to studying biological studies, such as using microscopic anatomy. The biological studies nowadays extend to molecular diagnostics, such as DNA analysis, mRNA analysis, sequencing, cell and tissue morphological analysis, and so on. The analysis is typically done very locally, and may therefore require microscopic tools to perform such an analysis. The study of biological samples may relate to the study of organs, the study of tissues, cytological analysis, the study of cells, animal tissues, plant tissues, and so on. Histology may be part of medicine studies, in order to study effects of e.g. pharmaceutical compositions, and medical treatment, or in medical diagnosis, of tissue cells, which typically are necrotic or apoptotic. Similar analysis may also be used in fields wherein tissue samples are analyzed, such as in the field of paleontology.

Tissue sample preparation may involve several steps, such as fixation, selection and trimming, dewatering, impregnating, embedding, sectioning, staining, and optionally further, specialized techniques. Fixation is used to preserve and maintain the structure of tissues and/or cells. As fixation typically also hardens tissues it improves cutting thin sections of a tissue. A down-side is that fixatives generally irreversibly cross-linking proteins, and similarly DNA and RNA; it can cause irreversible damage (e.g., hydrolysis of a phosphodiester bond and/or deamidation) to the structure of nucleic acids (e.g., DNA, and especially RNA). Accordingly, fixing and processing of a (tissue) sample into a paraffin block limits the application of genetic techniques. The most widely used fixative is formaldehyde, or formaldehyde in phosphate buffered saline. Formaldehyde is carcinogenic.

In the process of sample preparation relevant tissue may be selected, non-relevant tissue may be removed, the tissue may be embedded typically in a harder medium, section of the tissue may be obtained, the tissue may be stained with a suitable compound, and the tissue may be further processed. In general, water is removed from the tissue sample (dehydration) and water may be replaced with a medium that either solidifies directly, or with an intermediary fluid (clearing) that is miscible with the embedding media. Paraffin wax is typically used for embedding of the tissue sample.

A prior art method for preparing a sample (e. g. tissue) for histology involves incubation of the sample in a separate solution of phosphate-buffered 10% formaldehyde for fixation, incubation in a series of increasing concentrations of alcohol for dehydration, and incubation in xylene for clearing tissue of dehydration agent, prior to impregnation. Because of the time required for this process, usually 8 hours or longer, it is customary to complete these separate steps-fixation, dehydration, clearing, and impregnation-overnight in automated mechanical instruments designed for those tasks. A goal of tissue processing is to provide the sample with internal and external support from a medium of like hardness so that the specimen can withstand further processing and analysis, such as microtomy, without damage. The most common embedding or support medium is paraffin, but many other substances are also used. Microtomy is the process of cutting or sectioning an embedded sample or specimen into thin slices of approximately 2-8 microns in thickness with a sharp steel knife in a microtome. Slices are then picked up on slides, usually microscope slides. Standard paraffin processing procedures include exposure to chemical dehydration through graded alcohol solutions, then immersion in a transition solution (commonly referred to as a clearant) followed by impregnation with paraffin. Dehydration means the removal of water. During processing procedures, dehydration is used to remove the free water molecules and, if performed correctly, also the molecularly bound water. Dehydration is normally accomplished using alcohol solutions; most commonly ethanol, and isopropyl alcohol (isopropanol); occasionally methanol, or butanol for plant and animal tissue. If specimens are improperly dehydrated and water is left in the specimen, the clearant and impregnation agent (for example paraffin) will not penetrate the tissue and it will be soft and mushy. Excessive dehydration will remove the bound water, causing shrunken, hard, brittle specimens that require excessive rehydration before sectioning. Following dehydration of a sample, a “clearing” agent may be used to remove alcohol used for dehydration from the sample and to prepare the sample or specimen for the impregnation medium.

Clearing agents, also referred to as “dealcoholization” agents, must be miscible with both the dehydrating agent and the impregnation/embedding medium. Inadequate clearing, which can be caused by water remaining in the specimen or by inadequate exposure times, causes poor paraffin infiltration which will result in soft, mushy specimens. On the other hand, excessive exposure to clearing agents will produce hard, brittle specimens caused by the denaturation of the tissue proteins that is very similar to the effect of excessive dehydration.

Xylene (dimethylbenzene) has been the most widely used clearant for many years. It is an aromatic hydrocarbon that rapidly replaces alcohol and has a refractive index capable of rendering the tissue transparent. A major drawback of xylene is that it is very cumbersome to use, because it is highly volatile, flammable and a suspected carcinogen. Xylene should therefore only be used with adequate ventilation, and skin contact should be avoided. In addition, xylene is expensive.

A further drawback, particularly in a clinical setting, is that the process of formalin fixation takes generally 24 hours. Frequently it is desired to obtain a pathological examination of the tissue more quickly, e.g. during surgery.

The only known technique in pathology used to create diagnostic slices from fresh tissue, without any form of tissue fixation, involves freezing the tissues. Freezing, however, also comes with drawbacks. One such drawback is the implementation in the tissue of artifacts from freezing. Another drawback is that a large majority of the histochemical and immunohistochemical markers that are used in tissue diagnostics, do not work on frozen fresh tissue.

A background reference on an alternative method of obtaining a tissue sample is WO2005/001437 A1. Provided therein is a method for processing a biological sample for histological (or pathological) analysis, comprising contacting the sample with a composition comprising a supercritical or a near supercritical fluid, typically supercritical CO₂. This is followed by impregnating the sample with an embedding medium (typically paraffin) under a pressure of more than 1 bar. The tissue therein is contacted with or surrounded by a supercritical fluid, comprising pressurizing the sample with the composition comprising a (near) supercritical fluid to above the critical pressure of the supercritical fluid and heating the sample with the supercritical fluid to above the critical temperature of the supercritical fluid. The supercritical fluid, typically CO₂, penetrates a sample as it passes by a sample in a high-pressure vessel. The method is useful in that it allows avoiding the organic solvent xylene.

Further, US 2006/228810 A1 and US 2019/195556 A1 may be referred to. US 2006/228810 A1 recites processing of a biological sample for histological analysis. In particular, it relates to a rapid automated processing system that can be operated with continuous throughput and that eliminates the use of toxic solvents such as xylene. Provided is a method for processing a biological sample for histological analysis, comprising contacting the sample with a composition comprising a supercritical or near supercritical fluid followed by impregnating the sample under a pressure of more than 1 bar with an embedding medium, preferably paraffin. Also provided is a processor for preparing at least one sample for histological analysis, comprising at least one process reactor for the at least one sample, characterized in that the processor comprises supplying means (4) for supplying to the reactor at least one substance of which at least one is in supercritical phase or near supercritical phase and at least one supplying means for adding the embedding medium to the reactor through conduit. US 2019/195556 A1 recites a method that reduces consumption of intermediate fluid and/or transitional fluid, making the process more efficient in terms of duration and user interaction while ensuring a high degree of dryness and the integrity of the sample.

So, in the conventional method of preparing a tissue sample for histology, after removal from the patient, a tissue sample will first be fixated using an aqueous solution of formaldehyde, formalin. Prior to regular histological diagnostics based on hematoxylineosin staining, possible additional (immune) histochemical staining or molecular diagnostics, the tissue will then have to be dewatered and impregnated with paraffin, the so-called “processing” of the tissues. As mentioned, formalin fixation is used to stop the metabolism, fixate the structure of the tissue sample and prepare the tissue sample for further processing such as sectioning and staining. Chemical fixation denatures proteins, among other things, by ‘crosslinking’, in which enzymes become inactive, and autolysis (self-destruction of a cell) is prevented. However, formalin also causes single-strand breaks in the DNA. Modern molecular diagnostics techniques (including Whole Genome Sequencing) require that the DNA remains intact as much as possible, making formalin-fixed tissue samples less suitable for use in molecular diagnostics in general and unsuitable for Whole Genome Sequencing in particular. Without the use of formalin, substantial more DNA from the tissue samples is available. A current method of preserving tissues to which Whole Genome Sequencing is applied is freezing the tissues at −80° C. However, the percentage of a good sequencing result is low. In addition, few laboratories have a freezer with the required freezing capacity.

In summary, basic steps in tissue sample preparation are fixation with formalin prior to dewatering, tissue processing relating to dewatering and impregnation with paraffin in a machine, clearing relating to removal of ethanol (with bound water molecules) with xylene, and impregnation relating to impregnation with paraffin.

It would be desired to provide a method of preparation of a sample of fresh human or animal, without formalin fixation, that allows the application of a wide range of histochemical and immunohistochemical markers. It would also be desired to provide a method of preparation of a sample of fresh human or animal tissue, without freezing, that allows fast diagnostics and that allows genetic diagnostics, such as Whole Genome Sequencing. Despite speculation in WO 2005/0101437, it has not hitherto been possible to process anon-fixed, particularly a formalin free, non-frozen tissue sample for these purposes.

The present invention therefore relates to an improved method of preparing a tissue sample, and various aspects thereof, and a prepared tissue sample, which overcomes one or more of the above disadvantages, without jeopardizing functionality and advantages.

### SUMMARY OF THE INVENTION

In order to better address one or more of the aforementioned desires, the present invention relates, in several aspects, to treating a fresh tissue sample, as well as to samples thereby obtained.

In a first aspect the invention relates to a method of preparing a tissue sample, in particular a non-frozen tissue sample obtained from a human or animal subject, which can be done in a single tissue processor or environment, comprising obtaining a fresh tissue, that is substantially having its original qualities unimpaired, e.g. less than 1 hour old after obtaining the tissue, comprising a multitude of cells, in particular a multitude of living cells, providing an increased-pressure environment, wherein the increased pressure environment is configured to remove water from the multitude of cells, that is substantially dehydrates the sample, removing water from the multitude of cells by using a mixture of CO₂ and at least one C₁-C₄ alcohol or C₁-C₄ alkanol under supercritical or near-supercritical conditions, wherein the mixture comprises 20-90 wt. % C₁-C₄ alcohol or C₁-C₄ alkanol, in particular 40-80 wt. % C₁-C₄ alcohol or C₁-C₄ alkanol, more in particular 45-75 wt. % C₁-C₄ alcohol or C₁-C₄ alkanol, and a remainder CO₂, wherein wt. % are based on a total weight of the mixture, in particular ethanol, or wherein the mixture comprises 10-80 atom % CO₂ and 20-90 atom % of the at least one C₁-C₄ alcohol or C₁-C₄ alkanol, in particular 20-60 atom % CO₂, more in particular 25-55 atom % CO₂, during a water removal period, wherein the mixture is circulated over the multitude of cells and contacting the tissue sample over a circulation period, and obtaining a prepared tissue sample.

In a second aspect the present invention relates to a prepared tissue sample obtained by a method according to the invention. The tissue sample comprises <1 wt. % ketone or aldehyde, in particular formaldehyde, in particular <10⁻² wt. % ketone or aldehyde, more in particular <10⁻³ wt. % ketone or aldehyde. It will be understood that this reflects the substantial absence of a fixation agent, such as formaldehyde. Particularly, the tissue sample is characterized by being embedded with an embedding agent, such as paraffin, in conjunction with the aforementioned absence of a fixation agent such as formaldehyde.

In another aspect, the invention presents a method for embedding a fresh, non-frozen tissue sample from a human or animal subject, the method comprising:
(i) providing a native (particularly: non-fixated, non-frozen) tissue sample from a human or animal subject;
(ii) placing the native tissue sample in a reaction chamber;
(iii) adding an alcohol, preferably ethanol, to the reaction chamber containing the tissue sample;
(iv) pressurizing the reaction chamber containing the alcohol by means of CO2 under supercritical conditions so as to provide an environment comprising a mixture of said alcohol and supercritical CO2;
(v) replacing at least part of the mixture of alcohol and CO2 with fresh alcohol and CO2, so as to refresh the environment in the reaction chamber, thereby retaining conditions of supercritical CO2;
(vi) optionally repeating said refreshing of the environment;
(vii) subsequently flushing the reaction chamber with supercritical CO2;
(viii) subsequently adding an embedding liquid, preferably liquid paraffin to the reaction chamber, thereby allowing said embedding liquid to embed the tissue sample;
(ix) removing the embedded tissue sample from the reaction chamber.

In a still further aspect, the invention is a method for processing a fresh tissue sample for histological analysis, the method comprising:
(i) providing a fresh, non-frozen tissue sample from a human or animal subject;
(ii) treating the sample in accordance with any of the methods described above,
(iii) subjecting the prepared fresh tissue sample to embedding with an embedding medium, such as paraffin, so as to provide an embedded fresh tissue sample;
(iv) sectioning the embedded fresh tissue sample so as to obtain one or more fresh tissue sections;
(v) providing at least one fresh tissue section with at least one histological marker, such as a dye or an immunohistological marker;
   thereby obtaining a specimen for histological analysis.

In a next aspect the present invention relates to a method of analyzing with an analytical technique of a prepared tissue sample according to the invention. The analytical technique may be selected from DNA analysis, mRNA analysis, sequencing, such as gene by gene, Whole Genome Sequencing, and next generation sequencing (typically relating to part of a genome), cell and tissue morphological analysis, and combinations thereof. Thereto no longer a device for deep cooling, such as to liquid nitrogen temperatures, is required.

In yet another aspect, the invention presents a new type of tissue section for analysis, said tissue section being:
non-fixed, particularly not fixated with formalin;
embedded, particularly embedded in paraffin;
provided with at least one histological stain or histological marker;
wherein the section is from a fresh, non-frozen tissue.

In a further aspect the present invention relates to a method of analysing with an analytical technique of a prepared tissue sample according to the invention. The analytical technique may be selected from DNA analysis, mRNA analysis, sequencing, such as gene by gene, Whole Genome Sequencing, and next generation sequencing (typically relating to part of a genome), cell and tissue morphological analysis, and combinations thereof. Thereto no longer a device for deep cooling, such as to liquid nitrogen temperatures, is required.

Thereby the present invention provides a solution to one or more of the above mentioned problems.

Advantages of the present description are detailed throughout the description. References to the figures are not limiting, and are only intended to guide the person skilled in the art through details of the present invention.

### DETAILED DESCRIPTION OF THE INVENTION

The present invention relates in a first aspect to a method of preparing a tissue sample.

Though the invention is primarily directed to a multitude of cells, in principle it is also applicable to a smaller number of cells, and even individual cells. A fresh tissue is, apart from being obtained from a biological species, otherwise untreated, in particular it is not fixated. In general, in the field of pathology processing of a tissue sample refers to a combination of dehydration and impregnation of a tissue sample. It has been found that, in a preferred exemplary embodiment, when fresh (unfixed) tissues are placed under or in an environment wherein substantially all oxygen is removed, such as in a vacuum, or under an inert gas blanket, in a specific manner as soon as possible after removal from a patient and then dewatered with a mixture of supercritical CO₂ and ethanol, various characteristics of the tissue sample, in particular of the cells thereof, such as the DNA and morphology of the tissue sample, substantially remains intact. When dewatering non-formalin-fixed tissues with supercritical CO₂ and ethanol, a mixture of CO₂ and ethanol is passed along the tissues under supercritical or near-supercritical conditions. In an example, when this mixture of supercritical CO₂ and ethanol is refreshed or circulated during the dewatering process, dewatering is found to be more effective; therefore, a lower process temperature for dewatering will suffice. As a result, an even higher quality of sample characteristics and yield of for instance DNA, isolated from the tissue sample, is obtained. A supercritical mixture of ethanol and CO₂ has little or no surface tension, high solubility and penetrates deep into the tissues. The mild process conditions and the mild properties of CO₂, provide a morphology and DNA of the tissue sample that substantially remains intact.

For clarity, after tissue sample gathering, and optional fixation, the claimed method is performed. The above present mixture is used for dehydrating the sample, under the conditions mentioned, typically by circulating the mixture. Thereafter the sample o environment of dehydration is rinsed with CO₂. Thereafter the sample is typically impregnated, such as with paraffin, typically in the same environment. The impregnated sample may then be embedded, may be sectioned, may be stained primarily, may be stained in an advanced manner, and may then be used for image analysis and storage.

In an exemplary embodiment of the present method of preparing a tissue sample the mixture is flown over and/or surrounds the multitude of cells and wherein the mixture is contacting the tissue sample.

In an exemplary embodiment of the present method of preparing a tissue sample supercritical or near-supercritical conditions are an increased pressure of >7.37 MPa (737 bar), typically at a pressure of 8-15 MPa, such as <10 MPa.

In an exemplary embodiment of the present method of preparing a tissue sample supercritical or near-supercritical conditions are a temperature of >30° C., in particular at a temperature of 40-80° C.

In an exemplary embodiment of the present method of preparing a tissue sample supercritical or near-supercritical conditions are a period of >1 minute, in particular during 5-200 minutes, more in particular 60-180 minutes.

In an exemplary embodiment of the present method of preparing a tissue sample supercritical or near-supercritical conditions are reducing water to a 0.1-3 wt. % moisture content, and typically substantially all water is removed, more in particular substantially all remaining water, if any, is removed after/during impregnation.

In an exemplary embodiment of the present method of preparing a tissue sample the mixture is refreshed or circulated through the reactor with a circulation pump, in particular circulated through a conduit from the reactor to a circulation pump and back to the reactor, more in particular wherein the pressure in the reactor is substantially remained constant.

In an exemplary embodiment of the present method of preparing a tissue sample the mixture is circulated over the multitude of cells and contacting the tissue sample over a circulation period, wherein the circulation period is 50-100% of the water removal period, in particular wherein circulation is continuous or wherein circulation is intermittent. This method is also referred to as TISPA II.

In an exemplary embodiment of the present method of preparing a tissue sample the mixture is replaced at least once by a second mixture of CO2 and a C1-C4 alcohol or C1-C4 alkanol under supercritical or near-supercritical conditions after or during the water removal period, in particular replaced 2-5 times. This method is also referred to as TISPA I.

In an exemplary embodiment of the present method of preparing a tissue sample the mixture is circulated and replaced at least once, which may be considered a combination of the above TISPA I+II.

In an exemplary embodiment of the present method of preparing a tissue sample the tissue sample is selected from biological samples, in particular from a mammal sample, an animal sample, a plant sample, and a microbial sample, more in particular a mammal tissue sample, even more in particular a mammal organ tissue sample, such as a pancreas sample, a colon tissue sample, a prostate tissue sample, and a skin tissue sample.

In an exemplary embodiment of the present method of preparing a tissue sample before removing water, the tissue sample is placed under or in an environment wherein substantially all oxygen is removed, in particular a vacuum, and an inert gas blanket. Therewith the original qualities of the tissue sample remain substantially unimpaired, in particular characteristics such as morphology of the tissue sample, proteins in the tissue sample, DNA and RNA in the tissue sample, and so on.

In an exemplary embodiment of the present method of preparing a tissue sample, before removing water, the tissue sample is not fixated before removing water, in particular not fixated with a ketone or aldehyde, such as formaldehyde.

In an exemplary embodiment of the present method of preparing a tissue sample the tissue sample is impregnated after removing water, in particular impregnated with hydrocarbon comprising molecules, in particular molecules comprising between twenty and forty carbon atoms, such as a wax, in particular a paraffin wax. Removing water, in particular dehydrating a tissue sample, and impregnation of the dewatered tissue sample can be done in one apparatus, such as a TISPA.

In an exemplary embodiment of the present method of preparing a tissue sample impregnation is removed from the tissue sample in so far as applicable, in particular wherein excess impregnation is removed. Typically impregnation is performed using paraffin.

In an exemplary embodiment of the present method of preparing a tissue sample an amount of water in the tissue sample is reduced by >95 wt. %, in particular >99 wt. %, more in particular >99.9 wt. %, even more in particular >99.99 wt. %, such as >99.995 wt. %, wherein the weight percentage is calculated based on the initial weight of water.

In an exemplary embodiment of the present method of preparing a tissue sample removing water from the tissue sample and impregnation is performed within one and the same increased-pressure environment.

In an exemplary embodiment of the present method of preparing a tissue sample the in-creased-pressure environment is selected from a tissue processing apparatus, such as a closed-cycle gas turbine.

In a second aspect the present invention relates to a prepared tissue sample obtained by a method according to the invention.

In a third aspect the present invention relates to a method of analysing with an analytical technique of a prepared tissue sample according to the invention.

In another aspect, the invention presents a method for embedding a fresh, nonfrozen tissue sample from a human or animal subject. This method starts with providing a native non-fixated, non-frozen tissue sample from a human or animal subject. This sample is not initially subjected to any fixation, but is in its native state placed in a reaction chamber. The sample will generally be recognized as a fresh tissue sample. Preferably it is as fresh as possible, i.e., swiftly transferred after obtaining it from the subject (e.g. from the operation theatre directly), e.g. preferably within 4 hours, more preferably within a shorter time, such as within 1 hour. Longer periods, such as overnight or over the weekend are conceivable, provided that the sample is kept refrigerated (not frozen). The reaction chamber will typically be comprised in a tissue processing apparatus, such as Tispa I or Tispa II discussed in the present disclosure. The term “reaction chamber” does not imply that actually a chemical reaction will take place. In the present field it typically denotes the part of an apparatus in which one or more tissue samples can be subjected to dehydration, typically allowing subjecting the sample to elevated pressure and/or temperature, and where it can be provided with treatment liquids, notably one or more liquids aiding to dehydrate the tissue sample. Generally, the tissue sample will be put into a tissue sample holder, such as a plastic cassette, prior to having it enter the reaction chamber. Suitable tissue sample holders will be configured to allow receiving fluids, such as liquids aiding in dehydration, and to removing fluids, such as water removed upon dehydration.

The method comprises adding an alcohol, such as a C₁ to C₄ alkanol, preferably ethanol, to the reaction chamber containing the tissue sample. During or after adding the alcohol, the method comprises pressurizing the reaction chamber containing the alcohol by means of CO₂ under supercritical conditions. This results in an environment comprising a mixture of said alcohol and supercritical CO₂. The conditions, of pressure and temperature under which CO₂ is in a supercritical state are well-known to the skilled person, with reference to the phase diagram for CO₂.

It has been found to be beneficial for dehydrating a native (fresh, non-fixated, non-frozen) tissue sample, to refresh the environment in the reaction chamber during the processing of the sample. This is accomplished by replacing at least part of the mixture of alcohol and CO₂ with fresh alcohol and CO₂. Optionally, but preferably, said refreshing of the environment is repeated one or more time, preferably 2 to 5 times. The refreshing can also be conducted by continuous or intermittent circulation, as discussed hereinbefore. As a final step in dehydrating the sample, the method comprises flushing the reaction chamber with supercritical CO₂. Whilst generally maintaining the elevated pressure in the reaction chamber, an embedding liquid is added to the reaction chamber. Preferably this is liquid paraffin. Said embedding liquid is allowed to penetrate into the dehydrated sample, resulting in embedding it. Generally upon or after releasing the elevated pressure, the resulting embedded tissue sample can then be obtained from the reaction chamber.

In a still further aspect, the invention is a method for processing a fresh tissue sample for histological analysis. Herein a fresh, non-frozen tissue sample from a human or animal subject is treated in accordance with any of the methods described above, so as to provide a prepared, specifically dehydrated and embedded, fresh tissue sample. After obtaining the embedded sample, same is subjected to sectioning so as to obtain one or more fresh tissue sections. With a view to the histological analysis of the sample, the method comprises providing at least one such fresh tissue section with at least one histological marker. The resulting fresh tissue section thereupon is suitable as a specimen for histological analysis.

The term “histological marker” herein broadly covers those techniques familiar to a pathologist to render a tissue sample suitable for inspection, typically microscopic inspection and/or reviewing possible reaction of one or more antibodies with any antigens present in the sample. Typical markers are histochemical or immunohistochemical stains. Histochemical stains typically include dyes that bind directly on specific tissue structures. Histochemical markers include standard staining with HE (hematoxiline-eosine).

I immunohistochemical markers function on the basis of antigen-antibody complexation. A wide versatility of these markers exists, and provide highly specific bonding serving to determine cells on the basis of different qualities, such as origin, presence of proteins expressed in tumor cells, and aid, e.g., in determining whether a tumor might be responsive to a specific chemotherapy or hormone therapy.

Suitable histochemical markers include, but are not limited to HE (hematoxiline-eosine), which is a basis staining for generally all tissues.

PAS and PAS-diastase; this stain is preferential for mucus and mucins and binds to chitin, rendering it a useful histochemical stain for detecting funghi and yeast in tissues.

EVG (Elastica van Gieson), which is a combination of histochemical stains serving to mark a difference between elastin fibres, collagen fibres, muscle fibres, and fat. Suitable immunohistochemical markers include, but are not limited to:
Pankeratin: specifically marks epithelial tissue;
Keratin 7: specific for epithelium of the upper digestive tract, the lung, or mamma;
Keratin 20: specific for epithelium of the lower digestive tract or the bladder;
P63 and P40: specific for epithelium of squamous cells;
SOX-10: positive in melanocytic or neural cells;
S100: positive in melanocytic or neural cells;
PAX8: positive in epithelial cells from the urinary tract;
TTFT: positive in epithelial cells from lung or thyroid gland;
GATA3: positive in epithelial cells from mamma or bladder;
CDX2: positive in epithelial cells from the digestive tract;
ERG: positive in endothelial cells;
CD3 and CD5: markers specific for T-lymphocytes;
CD20, CD79a and PAX5: markers specific for B-lymphocytes;
CD138: marker specific for plasma cells.

In a next aspect the present invention relates to a method of analyzing genetic material taken from the embedded fresh tissue sample. To this end sample sections are provided from which DNA or RNA is obtained. This can be accomplished in a generally known manner, typically involving lysing, binding, washing and eluting the DNA or RNA. The obtained genetic material is processed further in a manner known for DNA or RNA analysis, particularly for New Generation Sequencing and Whole Genome Sequencing. These known sequencing techniques generally are automated techniques, for which various different brands of apparatus are available, and which are well-known to the skilled person.

A general issue in respect of analysis of DNA and RNA is the high sample quality required to successfully perform such analyses. Despite speculation in the past, it has hitherto not been proven in the art to provide a fresh, non-frozen tissue sample for successful analysis by means of Whole Genome Sequencing or Next Generation Sequencing. The specific method of tissue sample preparation of the present invention is the first method for which it has been found that said analytical techniques can be applied to fresh, non-frozen tissue, and actually yielding surprising results.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### SUMMARY OF FIGURES

FIG. 1 shows an exemplary prior art tissue processing flow.

FIG. 2-4 show an exemplary tissue processing flow according to the invention.

### DETAILED DESCRIPTION OF FIGURES

The figures are further detailed in the description of the experiments below.

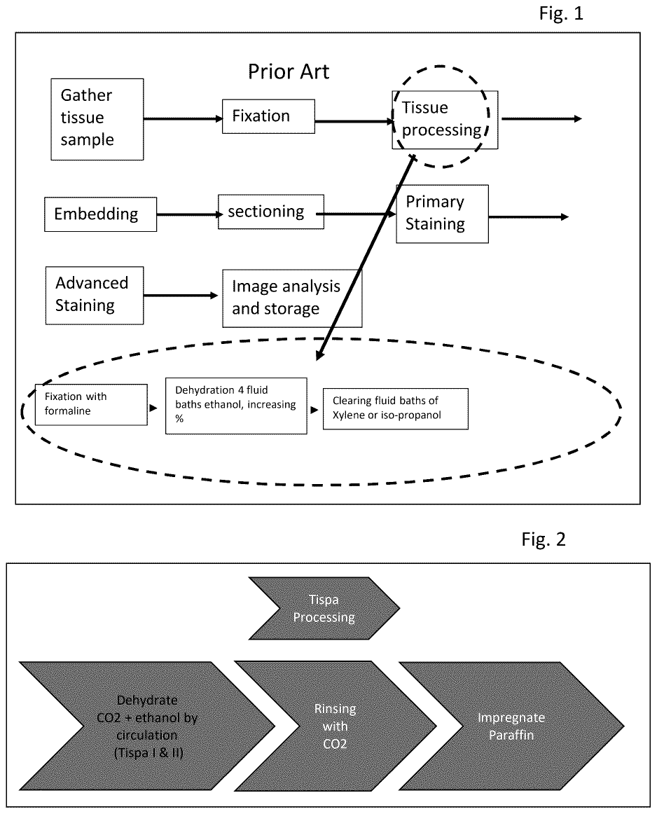

FIG. 1 shows a prior art tissue processing flow. Therein a tissue sample is provided which may be subjected to primary staining, advanced staining, and automated image analysis and storing of images and sample. A tissue sample is gathered, fixation is used in order to preserve the sample, the sample is processed, embedded in order to form a solid block or the like, and sectioned, such as by slicing using a microtome. A typical process time thereof is about 12 hours, or longer. For fixation of the tissue sample typically formalin is used. The tissue sample is than dehydrated, for example using four fluid baths, typically with an increasing concentration of ethanol. Then, xylene or iso-propanol may be used to clear the sample, and there after the cleared sample is infiltrated with paraffin.

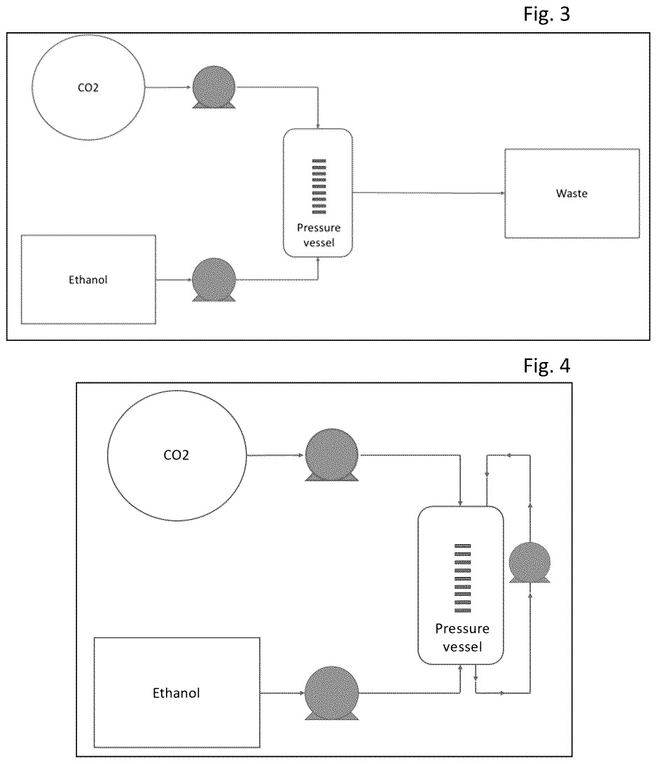

FIG. 2 shows an exemplary tissue processing flow according to the invention. Therein a supercritical mixture of ethanol and CO₂ is used to dehydrate a tissue sample, such as by circulation of said mixture over and in contact with the sample, rinsing with CO₂ in order to remove water, and impregnating with paraffin. The CO₂ rinsing also has the effect of removing impurities and the like.

FIG. 3 shows Tispa I hydration. 1. A determined amount of ethanol and CO₂ are led in the pressure vessel and brought under supercritical conditions. 2. After an interval period, fresh CO2 and a determined amount ethanol are led into the vessel and brought under supercritical conditions. Saturated CO2 and ethanol are flushed to the waste compartment. This refreshing takes place 1-3 times

FIG. 4 shows Tispa II dehydration. 1. A determined amount of ethanol and CO₂ are led into the pressure vessel and brought under supercritical conditions. 2. The supercritical mixture is circulated through the pressure vessel to maximize exposure of fresh unsaturated mixture to the tissue samples.

FIGS. 3-4 primarily relate to dewatering, so paraffin pumps, vacuum pumps and paraffin buffer vessels in this diagram are not included. Typically these are incorporated in the machine, but considered irrelevant to the dewatering step in which is circulated.

### Examples/Experiments

In general, Tispa Medical, of the Netherlands, provides suitable machines for performing the present method and for obtaining tissue samples. A process time of typically some 3 hours is required for gross cut fatty tissue, as an example. Therein a mixture of supercritical CO₂ and ethanol can be used. No pre- or post-treatment of the tissue is required; tissue is typically fixated. The present method provides a high water diffusion rate through the solvent and a low surface tension. Ethanol and water are typically flushed out, in a continuous mode, in a semi-continuous mode, or batch wise. Thereafter paraffin may be used, in the same equipment, to complete sample tissue preparation. Tispa 2 is a first of a new generation of machine enabling all these capabilities to be found in a single tissue processor. It offers clean, fast, versatile, and failure proof high quality tissue processing, setting the standard for the future of molecular diagnostics. It provides, in line with the present method, clean ethanol every run so no cross contamination; using CO₂ instead of xylene leads to bright staining of the tissues; a more efficient workload due to an even flow of tissues during the day, a high quality and yield of DNA/RNA results in superior molecular diagnostics. Fora patient this results in a reduced period of anxiety and uncertainty; a necessary treatment can commence faster; and zero chance of re-biopsy.

Typical process times are:

| Tissue Thickness | Process Time |
|---|---|
| Biopsies | 120 min |
| 1 mm | 120 min |
| 2-4 mm non fatty tissue | 150 min |
| 4 mm fatty tissue | 180 min |

### 1. “Tispa”

Non-formalin-fixated fresh human pancreas, colon and prostate specimens were placed in a 1 liter reactor. The reactor was maintained at a temperature of 60° C. The reactor was closed and ethanol was added to the reactor. The reactor was pressurized at 150 bar with carbon dioxide at 20° C. After 20 minutes, fresh ethanol and CO₂ at 40° C. was pumped in the reactor, while removing saturated ethanol and CO₂. This refreshing loop was repeated 2 times, with 20 minutes intervals. After 60 minutes, the reactor was flushed with fresh carbon dioxide during 30 minutes at a rate of 12 kg/h applying a pump, while maintaining the pressure at 150 bar applying a control valve. During this 30 minutes of flushing, the temperature was raised to 64° C. After 30 minutes, the pump was stopped and molten paraffine was added to the reactor, while maintaining the pressure at 150 bar. After 10 minutes, the reactor was depressurized in 18 minutes. Excess paraffin was drained from the reactor and the temperature in the reactor was lowered to 60° C., after which the embedded specimens were collected from the reactor. DNA and mRNA was isolated from the embedded specimens according conventional procedures.

### 2. “Tispa”

Non-formalin-fixated fresh human pancreas, colon and prostate specimens were placed in a 1.5 liter reactor. The reactor was maintained at a temperature of 58° C., The reactor was closed and ethanol was added to the reactor. The reactor was pressurized at 150 bar with carbon dioxide at 20° C. The mixture of ethanol and carbon dioxide was then circulated through the reactor with a circulation pump, while maintaining the pressure at 150 bar. After 45 minutes the reactor was flushed with fresh carbon dioxide during 30 minutes at a rate of 12 kg/h applying a pump, while maintaining the pressure at 150 bar applying a control valve. During the first 15 minutes of flushing with fresh carbon dioxide, the temperature was maintained at 58° C. and during the last 15 minutes of flushing with fresh carbon dioxide the temperature was increased to 64° C. After 30 minutes, the pump was stopped and molten paraffin was added to the reactor, while maintaining the pressure at 150 bar. After 10 minutes, the reactor was depressurized in 18 minutes. Excess paraffin was drained from the reactor and the temperature was lowered to 58° C., after which the embedded specimens were collected from the reactor. DNA and mRNA was isolated from the embedded specimens according conventional procedures. Below are some typical values of Tispa I and II, respectively.

| | Ethanol ml | Ethanol gr | CO2 g | % ethanol |
|---|---|---|---|---|
| Tispa I | | | | |
| XS | 450 | 355 | 250 | 58.7% |
| XL | 1150 | 908 | 300 | 75.2% |
| Tispa II | | | | |
| S | 600 | 474 | 500 | 48.6% |
| XL | 1020 | 805 | 600 | 57.3% |

### 3. Freeze Drying

Non-formalin-fixated fresh pancreas, colon and prostate specimens were flash freezed by immersing these specimens in liquid nitrogen after which the specimens where stored at −80° C. Subsequently, DNA and mRNA was isolated from these specimens.

### 4. Prior art Tissue Processing

Non-formalin-fixated fresh pancreas and colon specimens were placed in a retort and then exposed to graded alcohol solutions during 7 hours, after which the specimens were immersed in a clearant solution (xylene) during 3 hours. After this clearing step, the specimens were impregnated with paraffin during 5 hours. After these 15 hours, the specimens were then collected from the retort. The processed specimens were not suitable for further processing.

### 5. Invention Example—Histochemical and Immunohistochemical Stains

After receiving fresh operation specimen from the operation theatre at the department of Pathology, the pathologist inspects the tissue or organ and estimates the parts of the specimen needed to make the optimal diagnoses, according to WHO and local protocols, and determines the parts that can be appointed as residual tissue. Parts of these residual tissues were taken and anonymously used for tissue library building in a study, ethical committee approval provided.

For each sample, one part was processed in the conventional way, viz. 24 hours of fixation in buffered formalin, and then subjecting to dehydration and embedding.

This results in Formalin Fixed, Paraffin Embedded (FFPE) specimens. The second part was cut and directly, freshly subjected to dehydration and embedding. The resulting samples can be considered as Non Fixed, Paraffin Embedded (NFPE) specimens.

In both cases the dehydration and embedding process was the same, and conducted in accordance with the aforementioned TISPA II process. After throughput, the tissues were embedded in paraffin blocks and 3 μm thin sections were sliced at the microtome, ready to be stained. Paraffin embedded tissue blocks were stored in the usual archive, at room temperature.

Basic HE (hematoxylin and eosin) was performed on each included tissue block, both FFPE and NFPE samples. After HE staining, the tissue library is updated with information on the type of tissue, tumor or organ included in specific blocks.

A set of internationally widely used histochemical and immunohistochemical markers was selected to validate on the NFPE tissues, using the set of FFPE tissues as a comparison. Based on the types of tissues collected in the different tissue blocks of the library, at least two different blocks were selected for each marker.

The resulting staining patterns were scored based on the SAM principle:
S: Specificity; positive expression and negative expression as was expected and compared to the golden standard
A: Amount of background staining
M: Morphology: does the staining strengthen tissue patterns and not blur it.

### Results

The built tissue library contained a set of organs/tissues adequate to validate ten histochemical and ten immunohistochemical stains.

From all the collected tissues, first HE slides were created to observe if all expected or needed cell types or tissue types for specific markers were in the slide. No differences were observed in morphology between the FFPE tissues and the NFPE tissues.

From the list of histochemical markers, 6 markers (Elastica von Gieson, Giemsa, Masson Goldner, PAS, PAS-diastase and Schmorl) needed no adaptations to the standard (FFPE) protocol. For 3 markers (Alcian blue, Azan and Hale's iron), change of incubation time in the coloring step of the protocol provided specific, background free staining patterns with conservation of morphology. It will be understood that the skilled person will be able to adjust incubation times as a matter of routine. For one marker, reticulin, the standard protocol resulted in no staining at all, all possible adaptations resulted in no specific staining pattern. Dipping the cut slide in formalin for ten minutes after de-paraffination, before starting the standard protocol resulted in a very specific, background free staining pattern with conservation of morphology.

From the list of immunohistochemical markers, 5 markers (cytokeratin AE1/AE3, CDX2, e-cadherin, CD20 and SOX010) needed no adaptations the standard (FFPE) protocol. For 1 marker (TTF1), incubation time with the antibody was prolonged. For 1 marker (P63) incubation time was prolonged and an amplifier of the signal was added, resulting in a good and reliable expression without background staining or false-positive expression. For 1 marker (CD3) incubation time in CCl buffer was prolonged. For only two markers, CD68 and PAX-8 the possible adaptations to the standard protocol did not result in more specific staining with acceptable staining intensity and with less background staining.

Overall the study shows that the NFPE samples of the invention are very well suitable for histological analysis.

### 6. Invention Example—Next Generation Sequencing

Human tissue samples were obtained and processed in the same manner as in Example 5. Thereby for each tissue sample both an FFPE and an NFPE specimens were obtained. By means of Maxwell DNA extraction equipment, DNA is extracted from each specimen and isolated. The DNA concentration is measured in order to check that each sample to be analysed satisfies a required minimum value of 0.5 ng/μL. Each DNA sample is subjected to target amplification by means of PCR. By means of a Thermo Fisher Ion Chef sample preparation equipment and Ion S5 next generation sequencing system, the DNA is subjected to sequencing.

For all FFPE samples the amplification analysis showed “failure.” For all NFPE samples, the amplification analysis showed “OK.”

### 7. Invention Example—Whole Genome Sequencing

In the same manner as in Example 6, except for omitting the PCR step, FFPE and NFPE specimens are obtained for WGS (whole genome sequencing). Additionally, a comparison was made with frozen fresh tissue (which is he standard in the art for applying WGS). Accordingly, of each of three native tumor tissue samples, specimens were processed in 4 ways:
(A) FFPE conventional (formalin fixation, processing with xylene);
(B) FFPE Tispa (formalin fixation; processing with supercritical CO2);
(C) Frozen fresh (snap-frozen; no processing; stored in liquid nitrogen);
(D) NFPE according to the present invention.

DNA was extracted by means of a Qiagen DNA extraction kit, and sent to a dedicated laboratory for being subjected to WGS. Of all samples it was established that the total amount of DNA was sufficient to conduct WGS. The resulting DNA quality analysis data are provided in Table 1 below. Herein italics indicates “not good, below average” and bold indicates “good/above average”. As a result, all specimens in accordance with the invention (D) are acceptable for WGS, and even better than the standard in the art (C).

TABLE 1

| | | | | |
|---|---|---|---|---|
| DNA quality data | (A) | (B) | (C) | (D) |

Sample 1

| | | | | |
|---|---|---|---|---|
| Mean read length | 116 | 117 | 119 | 119 |
| Mapped reads | 995071 | 1000002 | 1772553 | 1487416 |
| % on target | 91.77 | 80.31 | 94.69 | 91.99 |
| mean depth | 3316 | 2917 | 6221 | 5035 |
| % amplicons with | 99.63 | 98.88 | 100.00 | 100.00 |
| at least 500 reads | | | | |

Sample 2

| | | | | |
|---|---|---|---|---|
| Mean read length | 107 | 110 | 123 | 117 |
| Mapped reads | 1301907 | 1071764 | 1656559 | 1382216 |
| % on target | 71.68 | 90.18 | 58.53 | 93.04 |
| mean depth | 3274 | 3427 | 3519 | 4601 |
| % amplicons with | 99.26 | 99.63 | 100.00 | 100.00 |
| at least 500 reads | | | | |

Sample 3

| | | | | |
|---|---|---|---|---|
| Mean read length | 121 | 119 | 131 | 117 |
| Mapped reads | 1271776 | 1280284 | 951689 | 1134681 |
| % on target | 75.10 | 93.71 | 37.03 | 92.22 |
| mean depth | 3408 | 4301 | 1290 | 3832 |
| % amplicons with | 98.88 | 99.26 | 94.80 | 100.00 |
| at least 500 reads | | | | |

The invention although described in detailed explanatory context may be best understood in conjunction with the accompanying figures.

It should be appreciated that for commercial application it may be preferable to use one or more variations of the present system, which would similar be to the ones disclosed in the present application and are within the spirit of the invention.

1. A method of preparing a tissue sample comprising Obtaining a fresh tissue comprising a multitude of cells,
Providing an increased-pressure environment, wherein the increased pressure environment is configured to remove water from the multitude of cells,
Removing water from the multitude of cells by using a mixture of CO2 and a selection of C1-C4 alcohol and C1-C4 alkanol under conditions selected from supercritical and near-supercritical conditions, wherein the mixture comprises a selection of 20-90 wt. % C₁-C₄ alcohol efand C1-C4 alkanol, and a remainder CO₂, during a water removal period, wherein wt. % are based on a total weight of the mixture, wherein the mixture is circulated over the multitude of cells and contacting the tissue sample over a circulation period, and
Obtaining a prepared tissue sample.

2. The method of preparing a tissue sample according to claim 1,
Wherein the mixture is subjected to a step selected from flowing over and surrounding the multitude of cells and wherein the mixture is contacting the tissue sample.

3. The method of preparing a tissue sample according to claim 1, wherein the conditions selected from super-critical and near-supercritical conditions are selected from an increased pressure of >7.37 MPa (737 bar), and
a temperature of >30° C., and
during a period of >1 minute, and
reducing water to a 0.1-3 wt. % moisture content.

4. The method of preparing a tissue sample according to claim 1, selected from wherein the mixture is subject to a selection from refreshed and circulated through the reactor with a circulation pump, wherein the pressure in the reactor is substantially remained constant, wherein the circulation period is 50-100% of the water removal period, wherein circulation is continuous or wherein circulation is intermittent,
and wherein the mixture is replaced at least once by a second mixture selected of CO2 and a C1-C4 alcohol and C1-C4 alkanol under a selection from supercritical and near-supercritical conditions selected from after and during the water removal period,
and wherein the mixture is circulated and replaced at least once.

5. The method of preparing a tissue sample according to claim 1, wherein the tissue sample is selected from biological samples.

6. The method of preparing a tissue sample according to claim 1, wherein, before removing water, the tissue sample is selected from placed under and in an environment wherein substantially all oxygen is removed, and
wherein the tissue sample, before removing water, is not fixated before removing water, and
wherein the tissue sample is impregnated after removing water.

7. The method of preparing a tissue sample according to claim 6, wherein impregnation is removed from the tissue sample.

8. The method of preparing a tissue sample according to claim 1, wherein an amount of water in the tissue sample is reduced by >95 wt. %, wherein the weight percentage is calculated based on the initial weight of water.

9. The method of preparing a tissue sample according to claim 6, wherein removing water from the tissue sample and impregnation is performed within one and the same increased-pressure environment.

10. The method of preparing a tissue sample according to claim 1, wherein the increased-pressure environment is selected from tissue processing apparatus.

11. The method of preparing a tissue sample according to claim 1, further comprising
sectioning the embedded fresh tissue sample so as to obtain one or more fresh tissue sections; and
providing at least one fresh tissue section with at least one histological marker, thereby obtaining a specimen for histological analysis.

12. A prepared tissue sample obtained by a method according to claim 1, wherein the tissue sample comprises a selection of <1 wt. % ketone aldehyde.

13. A method of analysing with an analytical technique of a tissue sample according to claim 12, wherein the analytical technique is selected from DNA analysis, mRNA analysis, sequencing, cell and tissue morphological analysis, and combinations thereof.

14. The method of preparing a tissue sample according to claim 1, comprising a multitude of living cells.

15. The method of preparing a tissue sample according to claim 4, wherein the mixture is circulated through a conduit from the reactor to a circulation pump and back to the reactor.

16. The method of preparing a tissue sample according to claim 6, wherein the tissue is not fixated with not fixated with a ketone or aldehyde, and wherein the tissue sample is impregnated with hydrocarbon comprising molecules.

17. The method of analysing according to claim 13 wherein the sequencing is Whole genome sequencing.
